(19) United States
(12) Patent Application Publication
(10) Pub. No.: US 2005/0122938 A1
(43) Pub. Date: Jun. 9, 2005

(54) Method and system for generating PLCM for BCMCS in a mobile communication system

(75) Inventors: Yu-Chul Kim, Seoul (KR); Dae-Gyun Kim, Seongnam-si (KR); Beom-Sik Bae, Suwon-si (KR); Jung-Soo Jung, Seoul (KR)

Correspondence Address: DILWORTH & BARRESE, LLP, 333 EARLE OVINGTON BLVD., UNIONDALE, NY, 11553, US

(73) Assignee: SAMSUNG ELECTRONICS CO., LTD., GYEONGGI-DO (KR)

(21) Appl. No.: 11/005,117

(22) Filed: Dec. 6, 2004

(30) Foreign Application Priority Data
Dec. 8, 2003 (KR) 88757/2003
Feb. 3, 2004 (KR) 7085/2004

(51) Int. Cl. H04B 17/00

(52) U.S. Cl. 370/335

(57) ABSTRACT

Disclosed is a method for generating a public long code mask (PLCM) so that a mobile station can receive a Broadcast/Multicast Service (BCMCS), in a mobile communication system including a base station and at least one mobile station located in a cell occupied by the base station, the BCMCS being provided from the base station to the mobile station. The PLCM is created by a combining a BCMCS flow identifier (BCMC_FLOW_ID) and a BCMC service reference identifier (BSR_ID) matched thereto from a BCMCS service parameter message (BSPM) including information related to the BCMC_FLOW_IDs indicating individual flow IDs for identifying flows from respective broadcasting stations and BSR_IDs matched to the BCMC_FLOW_IDs, the BSPM being transmitted from the base station to the mobile station over at least one channel.

### PRIORITY

This application claims priority under 35 U.S.C. § 119 to an application entitled “Method and System for Creating PLCM for BCMCS in a Mobile Communication System” filed in the Korean Intellectual Property Office on Dec. 8, 2003 and assigned Serial No. 2003-88757, and an application entitled “Method and System for Creating PLCM for BCMCS in a Mobile Communication System” filed in the Korean Intellectual Property Office on Feb. 3, 2004 and assigned Serial No. 2004-7085, the contents of both of which are incorporated herein by reference.

### BACKGROUND OF THE INVENTION

1. Field of the Invention

The present invention relates generally to a Broadcast/Multicast Service (BCMCS) method and system in a mobile communication system, and in particular, to a method and system for generating channel information for a BCMCS system.

2. Description of the Related Art

Currently, standardization for supporting a BCMCS beyond a voice service and a data service is being carried out on mobile communication systems. In order to receive a BCMCS, a mobile station should first detect on which channel which broadcast is being transmitted. Such broadcast-related information is transmitted through a BCMC Service Parameter Message (BSPM) or an In-Traffic Service Parameter Message, and the messages include channel information, flow information, and neighboring cell channel information for receiving a broadcast program (hereinafter, referred to as “Flow”) which is being broadcasted in a current cell. A base station determines the receptibility of a BCMCS according to a BCMC_FLOW_ID indicating Flow information (image, voice, and data) for a BCMCS, and transmits a BCMCS Registration Message according to the determination result. Although the BCMC_FLOW_ID is defined herein as an identifier (ID) indicating a Flow, it can also be defined as a BCMCS multicast Internet protocol (IP) Flow ID, i.e., an ID of a multicast IP address and its corresponding transport layer port number. A plurality of BCMC_FLOW_IDs can be mapped to each Flow. That is, independent BCMC_FLOW_IDs can be mapped to image, voice and data of one Flow. The BCMC_FLOW_ID is specified in a broadcast-related standard, and is well known to those skilled in the art.

The reason for determining the receptibility of the BCMC_FLOW_ID is because there is no way to inform a mobile station of the possibility of a BCMCS, except for a broadcast overhead message.

In a conventional Code Division Multiple Access (CDMA) mobile communication system, long codes (LCs) are used to identify users and obtain a data scrambling effect for forward traffic of a unicast service. The use of the long codes can provide security in a limited level to users, and disperse interference between the users by scrambling user data.

Generally, a long code for a frequently used BCMCS is defined as a public long code, and the public long code is created through the use of a public long code mask (PLCM). The PLCM is uniquely made based on unique mobile station information, such as an electronic serial number (ESN), in order to prevent correlation between PLCMs. Therefore, the data transmitted from a base station to a particular mobile station can be restored by only a user who knows the PLCM through a descrambling operation.

However, in a broadcast system currently under discussion, the use of dedicated channels uniquely allocated to specific users causes a waste of resources due to a characteristic of a BCMCS that simultaneously transmits the same Flow through many channels. Therefore, a base station transmits a Flow using a shared channel, and users descramble the broadcast channel transmitting the Flow with the same PLCM. In order to descramble a desired broadcast channel, a mobile station receiving the broadcast must know a PLCM for the corresponding channel in addition to its unique PLCM.

A BCMCS under discussion in the current CDMA2000 1× system can be provided to a mobile station in an idle state or a traffic state. In the traffic state, a base station specifically allocates a PLCM to a mobile station through an Extended Channel Assignment Message (ECAM), an Extended Supplemental Channel Assignment Message (ESCAM), a Universal Handoff Direction Message (UHDM), etc. The base station informs the mobile station of 39 bits necessary for the PLCM creation through an ADD_PLCM_FOR_FCH_{—}39 field or an ADD_PLCM_FOR_SCH_{—}39 field in the foregoing messages.

For the BCMCS under discussion, there have been proposed two methods: one method for specifically writing the PLCM-related information in a BSPM and informing a mobile station of the PLCM information, and another method for automatically making a PLCM based on previously received broadcast information.

Of the methods, the method for informing a mobile station of PLCM information creates a PLCM by including an ADD_PLCM_FOR_FCH_{—}39 or ADD_PLCM_FOR_SCH_{—}39 field in a BSPM, as done in the traffic state.

However, for a PLCM, an ADD_PLCM_FOR_FCH_{—}39 or ADD_PLCM_FOR_SCH_{—}39 field should be included in a BSPM for each broadcast physical channel, and the ADD_PLCM_FOR_SCH_{—}39 field has a length of 39 bits. Considering that the maximum number of channels supportable in a BSPM is 127 (=2⁷−1), the BSPM increases by a maximum of 4953 (=127*39) bits in size. Therefore, when the broadcast is received in the idle state, if different PLCMs are included in the BSPM for respective channels, the BSPM excessively increases in size.

Of the methods, the method for creating a required PLCM using broadcast information not directly related to the PLCM is proposed to create a PLCM using BCMC_FLOW_ID. The BSPM includes BCMC_FLOW_ID list, physical channel information, and neighbor base station information, all of which a mobile station requires in order to receive the broadcast. Currently, a maximum of 32 bits can be allocated to the BCMC_FLOW_ID.

With reference to the accompanying drawings, a description will be made of a method for creating a PLCM using the allocated values.

FIG. 1 is a diagram illustrating a general configuration of a mobile communication system for creating a PLCM. Referring to FIG. 1, BCMC_FLOW_ID#1 61, BCMC_FLOW_ID#2 62, and BCMC_FLOW_ID#3 63 are transmitted from a base station 20 for a cell A over a channl#1 31 after being multiplexed, and BCMC_FLOW_ID#1 64 is transmitted from the same cell over a channel#2 32. Actually, within one channel, Flows are identified by BCMC Service Reference Identifiers (BSR_IDs), and a mobile station 10 demultiplexes the Flows, maps the demultiplexed Flows with BCMC_FLOW_IDs, and delivers the mapping results to its upper layer. Herein, the BSR_IDs are used for identifying a plurality of logical streams transmitted over one physical channel such as a supplemental channel (SCH) or a packet data channel (PDCH). For each stream, an identity that processes each stream includes a service reference instance. The BCMC_FLOW_ID is specified in the broadcast-related standard (L3 spec), and is well known to those skilled in the art.

For PLCMs 41 and 42 of the channels 31 and 32, BCMC_FLOW_ID values of a maximum of 32 bits can be included in BCMC_FLOW_ID parts, and the remaining bits can be designated according to use of the PLCMs. Ends of the channels correspond to parts by which long codes are multiplied.

As illustrated in FIG. 1, if the PLCMs are made using minimum Flow numbers supported by the channels 31 and 32, the channels 31 and 32 both create PLCMs using BCMC_FLOW_ID#1. Therefore, the PLCMs 41 and 42 are equal to each other.

When one Flow is transmitted over two or more channels in this way, the two or more channels can select the same PLCM. However, the use of the same PLCM by the different two channels reduces a dispersion effect of interference between channels, causing a reduction in reception performance.

This method simply creates a PLCM using only BCMC_FLOW_ID, and does not need to separately manage the PLCM. Generally, however, because a BCMCS system which is a packet-based system can multiplex several Flows and transmit the multiplexed Flows over one channel, instead of broadcasting only one Flow with one channel, the method cannot be used in the situation where several Flows are transmitted over one channel.

### SUMMARY OF THE INVENTION

It is, therefore, an object of the present invention to provide a method and system for automatically creating different public long code masks (PLCMs) for respective channels by a mobile station and a base station using supplemental information without loading PLCMs for broadcast channels on a BCMC Service Parameter Message (BSPM).

It is another object of the present invention to provide a method and system for allowing a mobile station to perform a soft combining by automatically generating a PLCM for a channel over which the same Flows are transmitted by different cells.

According to a first aspect of the present invention, there is provided a method for generating a public long code mask (PLCM) so that a mobile station can receive a Broadcast/Multicast Service (BCMCS), in a mobile communication system including a base station and at least one mobile station located in a cell occupied by the base station, the BCMCS being provided from the base station to the mobile station. The PLCM is created by a combination of a BCMCS flow identifier (BCMC_FLOW_ID) and a BCMC Service Reference identifier (BSR_ID) matched thereto from a BCMCS parameter message (BSPM) including information related to a plurality of BCMC_FLOW_IDs indicating individual flow IDs for identifying flows from respective broadcasting stations and BSR_IDs matched to the BCMC_FLOW_IDs, the BSPM being transmitted from the base station to the mobile station over at least one channel.

According to a second aspect of the present invention, there is provided a method for generating a public long code mask (PLCM) by a mobile station so that the mobile station can receive a Broadcast/Multicast Service (BCMCS), in a mobile communication system including a base station and at least one mobile station located in a cell occupied by the base station, the BCMCS being provided from the base station to the mobile station. The method includes the steps of receiving over at least one channel a BCMCS parameter message (BSPM) from the base station, the BSPM including information related to BCMCS flow identifiers (BCMC_FLOW_IDs) indicating individual flow IDs for identifying flows from respective broadcasting stations and BCMCS reference identifiers (BSR_IDs) matched thereto; selecting a BCMC_FLOW_ID and a BSR_ID matched thereto in the information included in the received BSPM; and generating a PLCM unique in the cell, using the selected BCMC_FLOW_ID and a BSR_ID matched thereto.

According to a third aspect of the present invention, there is provided a method for generating a public long code mask (PLCM) by a mobile station so that the mobile station can receive a Broadcast/Multicast Service (BCMCS), in a mobile communication system including a base station and at least one mobile station located in a cell occupied by the base station, the BCMCS being provided from the base station to the mobile station. The method includes the steps of soft-combining channels from respective base stations located in different cells; receiving a BCMC service parameter message (BSPM) from the base station over the soft-combined channel, the BSPM including information related to BCMCS flow identifiers (BCMC_FLOW_IDs) indicating individual flow IDs for identifying flows from respective broadcasting stations and BCMC service reference identifiers (BSR_IDs) matched to the BCMC_FLOW_IDs; selecting a BCMC_FLOW_ID and a BSR_ID matched thereto in the information included in the received BSPM; and generating a PLCM unique in the cell, using the selected BCMC_FLOW_ID and a BSR_ID matched thereto.

According to a fourth aspect of the present invention, there is provided a method for generating a public long code mask (PLCM) so that a mobile station can receive a Broadcast/Multicast Service (BCMCS), in a mobile communication system including a base station and at least one mobile station located in a cell occupied by the base station, the BCMC service being provided from the base station to the mobile station. The method includes the steps of generating by the base station a BCMC service parameter message (BSPM) including information on BCMCS flow identifiers (BCMC_FLOW_IDs) indicating individual flow IDs for identifying flows from respective broadcasting stations and BCMC service reference identifiers (BSR_IDs) matched thereto; and transmitting the created BSPM to the mobile station over at least one channel.

According to a fifth aspect of the present invention, there is provided a system for generating a public long code mask (PLCM) so that a mobile station can receive a Broadcast/Multicast Service (BCMCS), in a mobile communication system including a base station and at least one mobile station located in a cell occupied by the base station, the BCMCS being provided from the base station to the mobile station. The system includes the base station for transmitting a BCMC service parameter message (BSPM) to the mobile station over at least one channel, the BSPM including information related to BCMCS flow identifiers (BCMC_FLOW_IDs) indicating individual flow IDs for identifying flows from respective broadcasting stations and BCMC service reference identifiers (BSR_IDs) matched to the BCMC_FLOW_IDs; and the mobile station for selecting a BCMC_FLOW_ID and a BSR_ID matched thereto from the BSPM received from the base station, and generating a PLCM unique in the cell, using the selected BCMC_FLOW_ID and a BSR_ID matched thereto.

### BRIEF DESCRIPTION OF THE DRAWINGS

The above and other objects, features and advantages of the present invention will become more apparent from the following detailed description when taken in conjunction with the accompanying drawings in which:

FIG. 1 is a diagram illustrating a general configuration of a mobile communication system for generating a public long code mask (PLCM);

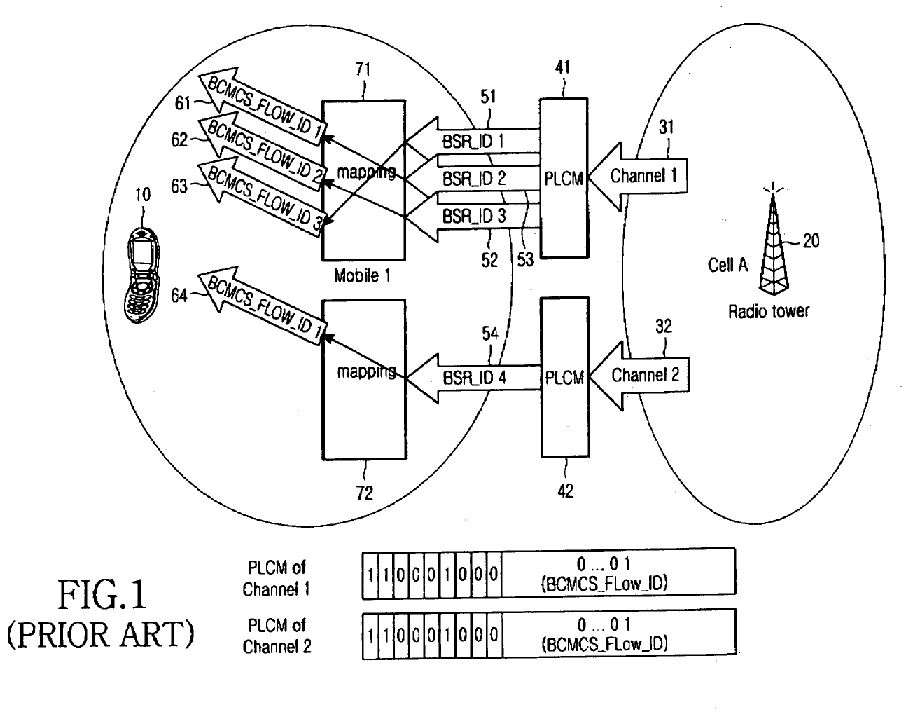

FIG. 2 is a diagram illustrating a configuration of a mobile communication system for generating a PLCM according to a first embodiment of the present invention;

FIG. 3 is a diagram illustrating a format of a BCMC Service Parameter Message (BSPM) according to embodiments of the present invention;

FIG. 4 is a diagram illustrating a format of a PLCM according to embodiments of the present invention;

FIG. 5 is a diagram illustrating a method of generating a 42-bit PLCM according to embodiments of the present invention;

FIGS. 6A and 6B are diagrams illustrating formats of a BSPM including Flow information and channel information according to embodiments of the present invention; and

FIG. 7 is a diagram illustrating an operation of simultaneously receiving channels transmitting broadcast information and soft-combing the received channels according to a second embodiment of the present invention.

### DETAILED DESCRIPTION OF THE PREFERRED EMBODIMENT

Several preferred embodiments of the present invention will now be described in detail with reference to the annexed drawings. In the following description, a detailed description of known functions and configurations incorporated herein has been omitted for conciseness.

In an embodiment of the present invention, in order to increase the reception performance of a BCMCS of a mobile station, the mobile station extracts a public long code mask (PLCM) using information in a BCMC Service Parameter Message (BSPM). In addition, the mobile station simultaneously uses a BCMC_FLOW_ID and a BCMC Service Reference Identifier (BSR_ID) transmitted with a BSPM to create a PLCM using supplemental information. The BSR_ID is an ID for identifying information related to a plurality of broadcast programs (hereinafter, referred to as “Flows”) which are transmitted over one channel. Herein, a base station can select one of a first method for allocating an index for generating a PLCM for all broadcast channels using the BSPM, a second method for generating a PLCM using BCMC_FLOW_ID and BSR_ID, and a third method for separately using the above two methods for respective channels, and instruct a mobile station to use the selected method. That is, a method in which a mobile station uses a PLCM is selected according to a value of FSCH_PLCM_SCHEME_IND field included in the BSPM.

Now, with reference to the accompanying drawings, a description will be made of a system configuration for generating a PLCM, and formats of a BSPM and a PLCM.

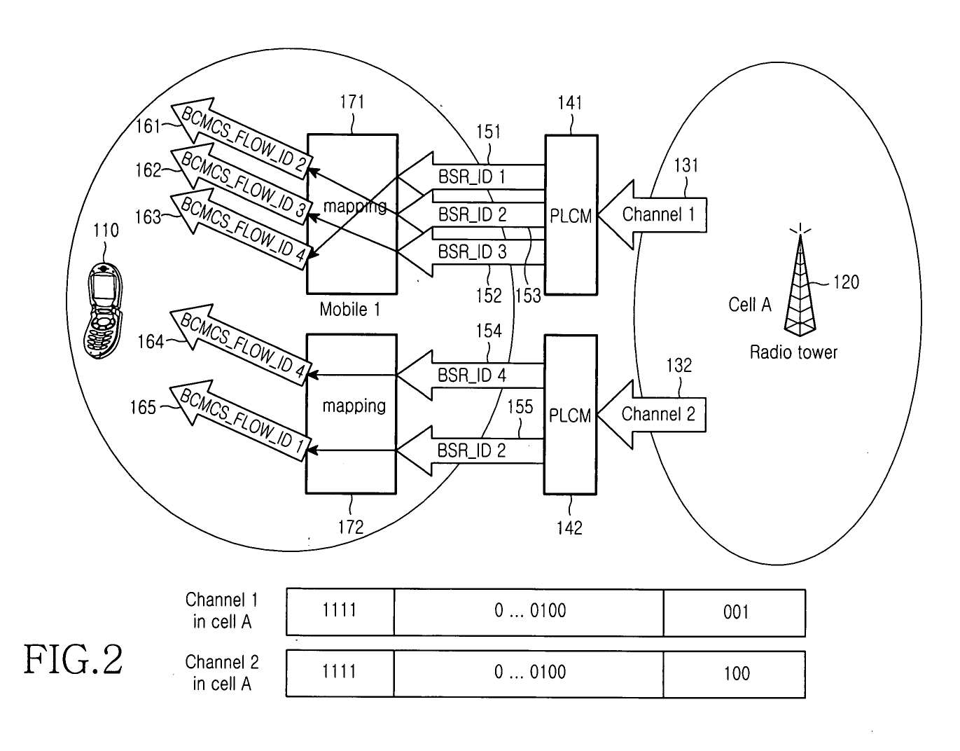

FIG. 2 is a diagram illustrating a configuration of a mobile communication system for generating a PLCM according to a first embodiment of the present invention.

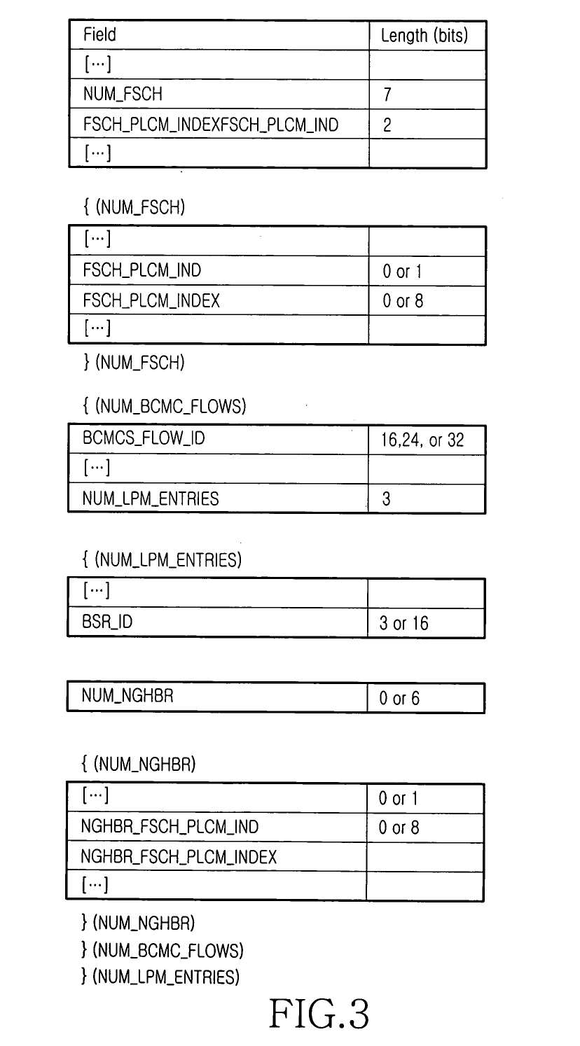

In a current CDMA2000 1× BCMCS system, BSR_IDs are used to identify several Flows in one channel. In the mobile communication system for generating PLCMs, a base station 120 loads information related to Flows on channels 131 and 132, multiplexes the information-loaded channels 131 and 132, and transmits the multiplexed channels to a mobile station 110. Here, the information related to Flows is information on BCMC_FLOW_IDs indicating individual Flow IDs for identifying Flows from respective broadcasting stations and BSR_IDs matched thereto. Therefore, the base station 120 informs the mobile station 110 of combined information of one BCMC_FLOW_ID and BSR_ID matched thereto. One or more BCMC_FLOW_IDs can be transmitted over one channel. The information related to the Flows is included in the BSPM. A detailed description of the BSPM will be made with reference to FIG. 3.

The mobile station 110 distinguishes between the received Flows multiplexed with the channels 131 and 132 using a pair of one BCMC_FLOW_ID and a BSR_ID matched thereto in the base station 120, with BSR_ID such that PLCMs should not overlap between channels in a cell A. Specifically, the mobile station 110 selects a BCMC_FLOW_ID and a BSR_ID matched thereto included in a BSPM from the base station 120, maps the BSR_ID to the BCMC_FLOW_ID, and delivers the mapping results to its upper layer. Here, the process of mapping the BSR_IDs to the BCMC_FLOW_IDs is not a process of adding new information or newly performing mapping, but a process of simply checking combinations of the BCMC_FLOW_IDs and the BSR_IDs made by the base station 120. Mapping information of the BCMC_FLOW_IDs and the BSR_IDs is received from the base station 120 through a BSPM.

Generally, the data received over a specific channel can be distinguished by the BSR_ID. Therefore, even though one Flow is transmitted through several channels, because the BSR_ID can be differently allocated, a pair of BCMC_FLOW_ID and BSR_ID can become a unique value. Because the pair of BCMC_FLOW_ID and BSR_ID becoming a unique value in a certain cell means that a PLCM is also unique in the cell, there is a very low possibility that the same PLCM will be allocated to different channels in a certain cell.

With reference to the accompanying drawings, a detailed description will be made of a format of a BSPM including information for generating the PLCM.

FIG. 3 is a diagram illustrating a format of a BCMC Service Parameter Message (BSPM) according to an embodiment of the present invention. In FIG. 3, { } indicates that a corresponding record is repeated as many times as a parenthesized parameter, and the BSPM is generally transmitted to a mobile station over a paging channel at stated periods.

Referring to FIG. 3, in a first record included in the BSPM, a NUM_FSCH field represents the number of forward supplemental channels (FSCHs), and a FSCH_PLCM_SCHEME_IND field represents a PLCM scheme indicator for an FSCH_PLCM scheme indication bits are illustrated in Table 1. The FSCH is a channel for actually transmitting a broadcast data stream from a base station to a mobile station, and usually the BSR_ID is included in a header part of the data stream. The FSCH is a well-known channel, so a detailed description thereof will be omitted herein for simplicity.

TABLE 1

| FSCH_PLCM_{—} | |
|---|---|
| SCHEME_IND (binary) | PLCM Scheme Used |
| 00 | This indicates a scheme of allocating an index |
| | through FSCH_PLCM_INDEX and |
| | generating a PLCM with the index value, and is |
| | applied to all FSCHs. |
| 01 | This indicates a scheme of generating a PLCM |
| | for a corresponding channel with |
| | BCMC_FLOW_ID and BSR_ID, and |
| | is applied to all FSCHs. |
| 10 | This indicates a scheme of selecting the index |
| | allocation scheme or the scheme of generating |
| | a PLCM using BCMC_FLOW_ID and |
| | BSR_ID, for each FSCH. |
| 11 | Reserved |

In Table 1, an indication value of ‘00’ indicates a scheme of allocating an index through FSCH_PLCM_INDEX and generating a PLCM with the index value, and is applied to all FSCHs. An indication value of ‘01’ indicates a scheme of generating a PLCM for a corresponding channel with a BCMC_FLOW_ID and a BSR_ID, and is applied to all FSCHs. An indication value of ‘10’ indicates a scheme of selecting the index allocation scheme or the scheme of generating a PLCM using BCMC_FLOW_ID and BSR_ID, for each FSCH. An indication value of ‘11’ indicates a reserved value.

Referring back to FIG. 3, an FSCH_PLCM_IND field included in a second record represents an FSCH PLCM scheme indicator, is included when the FSCH_PLCM_SCHEME_IND field is set to ‘10’, and has a length of 0 or 1 bit. If a PLCM is created with the index allocation scheme, the FSCH_PLCM_IND field is set to ‘1’, and if a PLCM is created using a BCMC_FLOW_ID and a BSR_ID, the FSCH_PLCM_IND field is set to ‘0’. An FSCH_PLCM_INDEX field included in the second record represents an FSCH PLCM creation index, and has a length of 0 or 8 bits. If the FSCH_PLCM_SCHEME_IND field is set to ‘00’ or the FSCH_PLCM_IND field is included and set to ‘1’, a base station includes this field, and if the FSCH_PLCM_IND field is set to another value, the base station omits the corresponding field. The base station sets an index with which it can create a PLCM used for an FSCH.

The second record has a variable length, and is repeated as many times as the NUM_FSCH.

A BCMC_FLOW_ID field included in a third record represents an ID of a Flow and has a length of 16, 24 or 32 bits, and a NUM_LPM_ENTRIES field included in the third record represents the number of logical and physical parameter mapping entries and has a length of 3 bits.

A BSR_ID field included in a fourth record represents a BCMC Service Reference Identifier and has a length of 3 or 16 bits, and a NUM_NGHBR field included in the fourth record represents the number of neighboring base station BCMCS parameters and has a length of 0 or 6 bits.

An NGHBR_FSCH_PLCM_IND field included in a fifth record represents a neighbor FSCH PLCH scheme indicator and has a length of 0 or 1 bit. If an NGHBER_FSCH_PARMS_INCL field is not included or it is included and set to ‘0’, the NGHBR_FSCH_PLCM_IND field is not included. Otherwise, if the index allocation scheme is used, the NGHBR_FSCH_PLCM_IND field is set to ‘1’. If a PLCM is created using a BCMC_FLOW_ID and its associated BSR_ID, the NGHBR_FSCH_PLCM_IND field is set to ‘0’.

An NGHBR_FSCH_PLCM_INDEX field included in the fifth record represents an index for generating a neighbor FSCH PLCM and has a length of 0 or 8 bits. If the NGHBR_FSCH_PLCM_IND field is not included or it is included and set to ‘0’, the base station omits the corresponding field. Otherwise, the base station includes the corresponding field and sets an index value for generating a PLCM used for an FSCH in the field.

The third record and its succeeding records are variable-length records and are repeated as many times as the NUM_BCMC_FLOWS, and the fourth record and its succeeding records are variable-length records and are repeated as many times as the NUM_LPM_ENTRIES. The fifth record is repeated as many times as the NUM_NGHBR.

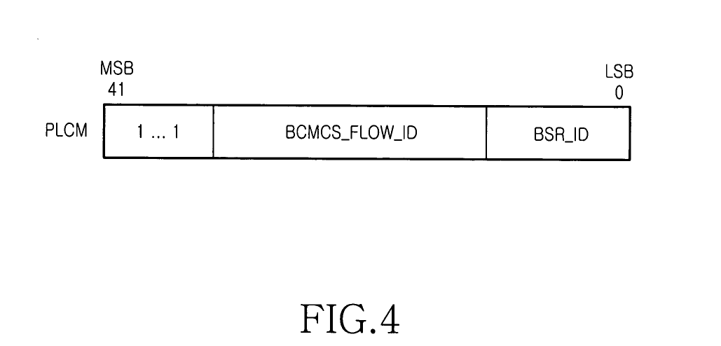

FIG. 4 is a diagram illustrating a format of a PLCM according to an embodiment of the present invention. Referring to FIG. 4, a PLCM has a 42-bit length, arranges the BSR_ID on a least significant bit (LSB) part, fills the next part with the BCMC_FLOW_ID, and fills a most significant bit (MSB) part or the remaining part with, for example, ‘1’s. Exemplary formats of the PLCM for respective channels are illustrated in FIG. 2. As illustrated in FIG. 2, BSR_ID is filled with ‘001’, and BCMC_FLOW_ID is filled with ‘0 . . . 0100’. Although the remaining part is filled with ‘1’s, it can also be filled with other bits. Herein, if the sum of a length of the BCMC_FLOW_ID and a length of the BSR_ID does not exceed 40 bits, a PLCM can be created in the foregoing manner. If BCMC_FLOW_ID has 32 bits and BSR_ID has 3 bits, 7 ‘1’s are inserted in the MSB part of the PLCM. However, if the sum exceeds 40 bits, another method should be used. A method for generating a PLCM in this case will be described herein below with reference to the accompanying drawings.

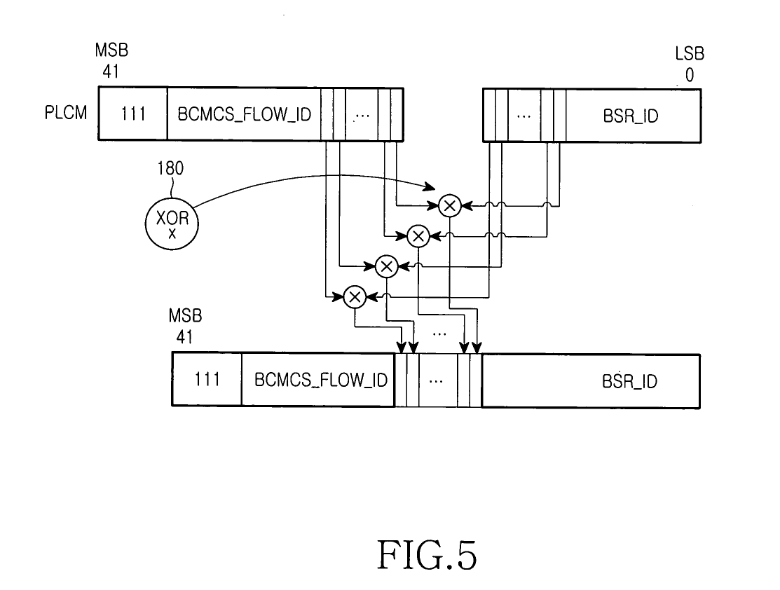

FIG. 5 is a diagram illustrating a method of generating a 42-bit PLCM according to an embodiment of the present invention. Referring to FIG. 5, because the sum of a length of the BCMC_FLOW_ID and the length of the BSR_ID exceeds 40 bits, a mobile station creates a 42-bit PLCM by XORing (180) higher bits of the BSR_ID and lower bits of the BCMC_FLOW_ID. Although 3 MSB bits are set herein to, for example, ‘1’s, they can also be set to other values.

With reference to the accompanying drawings, a description will now be made of a method for generating a PLCM by uniquely allocating a pair of BCMC_FLOW_ID and BSR_ID in the mobile communication system. First, a description will be made of a method for selecting a BCMC_FLOW_ID by the mobile station 110 in generating the PLCM.

The method for selecting a BCMC_FLOW_ID by the mobile station 110 includes several methods according to how Flows are arranged in a channel. If only one Flow is transmitted over one channel, only one BCMC_FLOW_ID exists per channel. Even when one Flow is transmitted over several channels, each channel has only one BCMC_FLOW_ID. However, when one channel transmits several Flows, one of the multiple BCMC_FLOW_IDs should be selected. The multiple BCMC_FLOW_IDs or the multiple pairs of BCMC_FLOW_IDs and BSR_IDs are received as parameters, any algorithm capable of selecting one BCMC_FLOW_ID or one pair of BCMC_FLOW_ID and BSR_ID is available, and a value corresponding to the selected BCMC_FLOW ID is selected as the BSR ID.

As one example of the foregoing selection algorithm, when a plurality of Flows are transmitted over a channel over which a Flow desired by a user is transmitted, the mobile station 110 can select a Flow having a minimum BCMC_FLOW_ID value or a maximum BCMC_FLOW_ID value from among the Flows. When the BCMC_FLOW_IDs have different lengths, the mobile station 110 pads upper bits of the BCMC_FLOW_ID having the shortest length with ‘0’s to match the length of the padded BCMC_FLOW_ID to the length of the BCMC_FLOW_ID having the longest length, and then compares the values of the BCMC_FLOW_IDs.

As another example of the foregoing selection algorithm, a specific Flow can be selected based on a format of a BSPM. The current BSPM includes mapping information regarding which Flow is transmitted over which channel. With reference to the accompanying drawings, a brief description will be made of how the Flow information and the channel information are arranged in the BSPM.

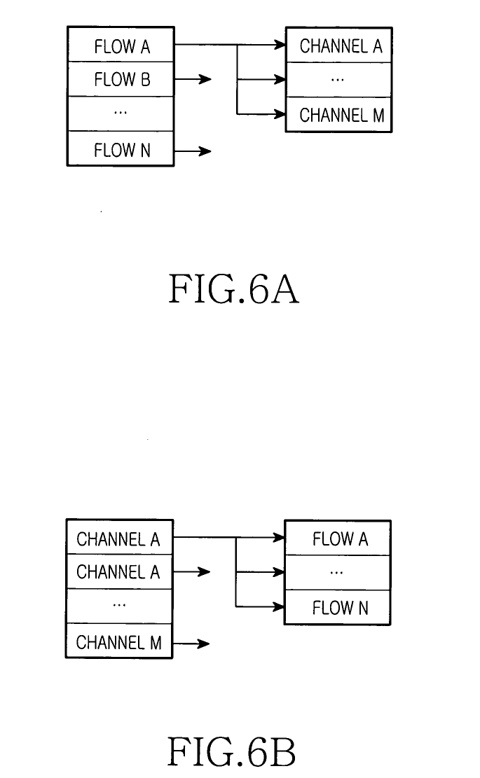

FIG. 6A illustrates a list of channels A, B, . . . , M for a Flow A in a BSPM, by way of example, from among the possible lists of channels over which corresponding Flows are transmitted. FIG. 6B illustrates a list of Flows A, B, . . . , N for a channel A in a BSPM, by way of example, from among the possible lists of Flows transmitted over the corresponding channels. FIG. 6B illustrates which Flows are transmitted over a specific channel. Here, one BCMC_FLOW_ID for a specific Flow should be selected in order to create a PLCM for a specific channel. As a method for selecting the BCMC_FLOW_ID, the uppermost BCMC_FLOW_ID or the lowermost BCMC_FLOW_ID can be selected. For example, if the uppermost Flow is selected as illustrated in FIG. 6A, the BCMC_FLOW_ID for the Flow A is selected.

A description will now be made of an operation of the PLCM creation method applied to FIG. 2 in which the BCMC_FLOW_ID#2 161, the BCMC_FLOW_ID#3 162 and the BCMC_FLOW_ID#4 163, and the BCMC_FLOW_ID#4 164 and the BCMC_FLOW_ID#1 165 are transmitted over two different channels 131 and 132 shared by all of the mobile stations 110 in a cell A.

The Flows are multiplexed before being transmitted over the respective channels 131 and 132, and a base station 120 transmits the information related to the BCMC_FLOW_IDs and the BSR_IDs to a mobile station 110 using a BSPM. Then the mobile station 110 creates the PLCMs by concatenating ‘1111’ of the upper bits to PLCM key values separately selected for the channels 131 and 132 according to the PLCM selection method. Thereafter, the mobile station 110 maps the BSR_IDs 151, 152, 153, 154 and 155 with the BCMC_FLOW_IDs 161, 162, 163, 164 and 165 for the respective channels 131 and 132, and transmits the Flows for the corresponding BCMC_FLOW_IDs to its upper layer.

As illustrated in FIG. 2, although the BCMC_FLOW_ID#4 163 and 164 is transmitted over two channels, it is mapped to the BSR_ID#1 151 in the channel 131 and the BSR_ID#4 154 in the channel 132, so that pairs of the BCMC_FLOW_IDs and BSR_IDs have different values. A table in the bottom of FIG. 2 illustrates a difference between the PLCMs 141 and 142, and both the BCMC_FLOW_ID for the channel#2 132 in the cell A and the BCMC_FLOW_ID for the channel#1 131 in the cell A are equal to the BCMC_FLOW_ID#4 (0, . . . , 0100). However, the BSR_ID is the BSR_ID#1 (001) for the channel# 131 and the BSR_ID#4 (100) for the channel#2 132.

If the corresponding BCMC_FLOW_ID and BSR_IDs are used in generating PLCMs even when selecting a Flow having the maximum value in the channel, because the BCMC_FLOW_IDs are identical to each other but the BSR_IDs are different from each other, the PLCMs for the two channels do not overlap each other.

The first embodiment of the present invention has been described with reference to an operation of generating PLCMs by receiving the Flows from a base station in a certain cell A through different channels. Next, a second embodiment of the present invention will be described with reference to an operation of generating the PLCMs when a cell A and a cell B transmit the same Flows and a mobile station receives channels having the same PLCM values.

Because even the different cells can make it possible to automatically create the same PLCM for the same Flows, a mobile station can perform soft combining. The soft combining operation will be described with reference to the accompanying drawings.

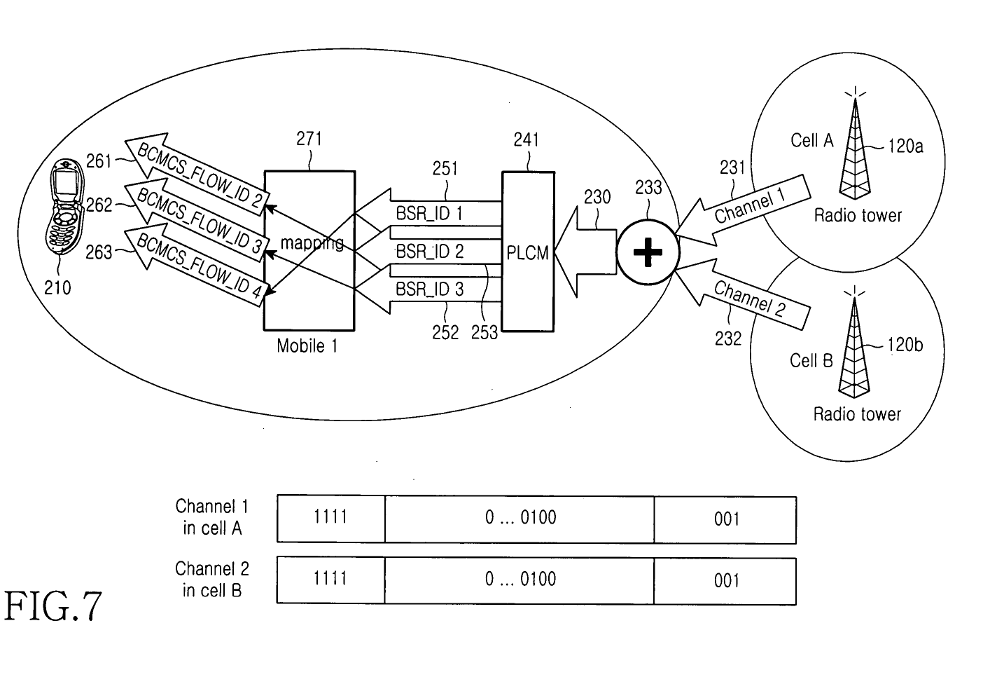

FIG. 7 is a diagram illustrating an operation of simultaneously receiving channels transmitting broadcast information and soft-combing the received channels according to a second embodiment of the present invention. Referring to FIG. 7, base stations 120a and 120b transmit the same Flows in cells A and B, respectively, and simultaneously transmit channels having the same PLCM value to a mobile station 210. The mobile station 210 receiving the BCMC_FLOW_ID#4 263 from the base stations 120a and 120b receives channels 231 and 232 from the cells A and B in a soft handover region and soft-combines the received channels. Actually, the mobile station 210 receives signals of the channels 231 and 232 and adds up the energies of the two signals.

Thereafter, the mobile station 210 descrambles the soft-combined signal with a long code at an end of the channels, demultiplexes the descrambled signals with the BSR_IDs, maps the demultiplexed signals to the BCMC_FLOW_IDs, and transmits the mapping results to its upper layer.

In the soft combining operation, the mobile station 210 located in a soft handover region receives all of the signals from both of the two base stations 120a and 120b. In order to receive the signals from the two channels 231 and 232 transmitting the same information, soft-combine the received signals and descramble the soft-combined signal, it is essential that the two channels should be scrambled with the same PLCM. In addition, if the values of the BCMC_FLOW_IDs and the BSR_IDs for the channels 231 and 232 transmitting the same information in all of the cells belonging to a soft-handover group are equal to each other, the channels 231 and 232 from the respective cells both have the same PLCM value. A table in the bottom of FIG. 7 illustrates the same PLCM 241 for the channels 231 and 232, by way of example, and both the BCMC_FLOW_ID for the channel#1 231 in the cell A and the BCMC_FLOW_ID for the channel#2 232 in the cell B are equal to the BCMC_FLOW_ID#4 (0, . . . , 0100), and both of the BSR_IDs for the channel#1 231 and the channel#2 232 are also equal to the BSR_ID#1 (001).

In this case, the mobile station 210 can receive the channel signals transmitting the same Flow from the different base stations 120a and 120b in a soft handover region, and soft-combine the received channel signals. Such an operation contributes to improvement in the reception performance, and enables soft combining. For the soft combining, signals received at a mobile station from the two base stations should be identical to each other in terms of the information acquired after despreading the signals with a Walsh code. Because the two signals are despread with the Walsh code and thereafter, the energies of the two signals are soft-combined and then descrambled with one long code, the two channels should also be scrambled with the same PLCM.

In the embodiment of the present invention, because the Flows are allocated the BSR_IDs in a predetermined rule in the channels transmitting the same information without the intervention of a base station, even different cells use the same PLCM, thereby enabling the soft combining.

As can be understood from the foregoing description, when one Flow is transmitted over several channels within one cell, a pair of a BCMC_FLOW_ID and a BSR_ID transmitted over each channel is artificially allocated such that it should be unique in the cell, thereby preventing the PLCMs from overlapping between the channels. The prevention of the PLCM overlapping disperses the interference between the channels, contributing to the performance improvement. In addition, because a base station and a mobile station create the PLCMs from their previous information in a predetermined method rather than allocating the PLCMs to the mobile station by the base station, radio resources can be saved.

While the invention has been shown and described with reference to a certain preferred embodiment thereof, it will be understood by those skilled in the art that various changes in form and details may be made therein without departing from the spirit and scope of the invention as defined by the appended claims.

1. In a communication system which provides a broadcast service to at least one mobile station via at least one base station, a method for providing a broadcast service comprising the steps of:
transmitting a broadcast service parameter message, wherein the broadcast service parameter message includes information related to channel used for transmitting a broadcast flow, a broadcast flow identifier identifying the broadcast flow and a broadcast service reference identifier;
generating a code mask using the broadcast flow identifier and the broadcast service reference identifier; and
transmitting the broadcast flow over the channel using the code mask.

2. The method of claim 1, wherein the generating the code mask comprises the steps of:
placing the broadcast service reference identifier on a part comprising the least significant bit of the code mask; and
placing the broadcast flow identifier on a part next to the broadcast service reference identifier.

3. The method of claim 2, further comprising step of placing a predetermined bit sequence on a remaining part of the code mask.

4. The method of claim 1, wherein the broadcast service parameter message further includes a plurality of broadcast flow identifiers and a plurality of broadcast service reference identifiers.

5. The method of claim 4, further comprising the step of selecting a broadcast flow identifier based on values of the broadcast flow identifiers in the broadcast service parameter message, the selected broadcast flow identifier being used in the generating step.

6. The method of claim 4, further comprising the step of selecting a broadcast flow identifier based on orders of the broadcast flow identifiers in the broadcast service parameter message, the selected broadcast flow identifier being used in the generating step.

7. In a communication system which provides a broadcast service to at least one mobile station via at least one base station, a method for receiving a broadcast service comprising the steps of:
receiving a broadcast service parameter message, wherein the broadcast service parameter message includes information related to channel used for receiving a broadcast flow, a broadcast flow identifier identifying the broadcast flow and a broadcast service reference identifier;
generating a code mask using the broadcast flow identifier and the broadcast service reference identifier; and
receiving the broadcast flow over the channel using the code mask.

8. The method of claim 7, wherein the generating the code mask comprises the steps of:
placing the broadcast service reference identifier on a part comprising the least significant bit of the code mask; and
placing the broadcast flow identifier on a part next to the broadcast service reference identifier.

9. The method of claim 8, further comprising step of placing a predetermined bit sequence on a remaining part of the code mask.

10. The method of claim 7, wherein the broadcast service parameter message further includes a plurality of broadcast flow identifiers and a plurality of broadcast service reference identifiers.

11. The method of claim 10, further comprising the step of selecting a broadcast flow identifier based on values of the broadcast flow identifiers in the broadcast service parameter message, the selected broadcast flow identifier being used in the generating step.

12. The method of claim 10, further comprising the step of selecting a broadcast flow identifier based on orders of the broadcast flow identifiers in the broadcast service parameter message, the selected broadcast flow identifier being used in the generating step.

13. In a cellular communication system which provides a broadcast multicast(BCMC) service to at least one mobile station via at least on base station, a method for generating a public long code mask (PLCM) by a mobile station which is used for receiving BCMC service comprising the steps of:
receiving a BCMC service parameter message (BSPM), wherein the BSPM includes at least one BCMC flow identifier and at least one BCMC service reference identifier;
selecting a BCMC flow identifier and a BCMC service reference identifier; and
generating a PLCM using the BCMC flow identifier and the BCMC service reference identifier.

14. The method of claim 13, wherein the BCMC flow identifier is selected based on orders of the BCMC flow identifiers in the BSPM.

15. The method of claim 14, wherein the BCMC flow identifier is selected as a first BCMC flow identifier on the BSPM.

16. The method of claim 13, wherein the BCMC flow identifier is selected based on values of the BCMC flow identifiers in the BSPM.

17. The method of claim 13, wherein the generating PLCM comprises the steps of:
placing the BCMC service reference identifier on a part comprising the least significant bit of the PLCM; and
placing the BCMC flow identifier on a part next to the BCMC service reference identifier.

18. The method of claim 17, further comprising step of placing a predetermined bit sequence on a remaining part of the PLCM.

19. A system for generating a public long code mask (PLCM) so that a mobile station can receive a Broadcast/Multicast (BCMC) Service, in a mobile communication system including a base station and at least one mobile station located in a cell occupied by the base station, the BCMCS being provided from the base station to the mobile station, the system comprising:
a base station for transmitting a BCMC service parameter message (BSPM) a over at least one channel, the BSPM including information related to BCMC flow identifiers (BCMC_FLOW_IDs) indicating individual flow IDs for identifying flows from respective broadcasting stations and BCMC service reference identifiers (BSR_IDs) matched to the BCMC_FLOW_IDs; and
a mobile station for receiving the BSPM from the base station and for selecting one of the BCMC_FLOW_IDs and a BSR_ID matched thereto from the BSPM, and generating a PLCM unique in the cell using the selected the BCMC_FLOW_ID and the BSR_ID matched thereto.

20. The system of claim 19, wherein in the selection process, a BCMC_FLOW_ID having one of the largest value and the smallest value is selected from the BCMC_FLOW_IDs received from the base station.

21. The system of clam 19, wherein in the selection process, one of the uppermost and lowermost BCMC_FLOW_ID included in the BSPM is selected.

22. The system of claim 19, wherein the BSPM is transmitted to the mobile station over a paging channel at stated periods.
